(19) United States
(12) Patent Application Publication
(10) Pub. No.: US 2026/0092651 A1
(43) Pub. Date: Apr. 2, 2026

(54) VALVE DEVICE AND GAS WATER HEATER

(71) Applicants: GUANGDONG MIDEA KITCHEN AND BATH APPLIANCES MFG. CO., LTD., Foshan (CN); WUHU MIDEA KITCHEN AND BATH APPLIANCES MFG. CO., LTD., Wuhu (CN)

(72) Inventors: Jiqing MA, Foshan (CN); Hongbin ZHANG, Foshan (CN); Feng LIU, Foshan (CN); Ke SONG, Foshan (CN)

(73) Assignees: GUANGDONG MIDEA KITCHEN AND BATH APPLIANCES MFG. CO., LTD., Foshan (CN); WUHU MIDEA KITCHEN AND BATH APPLIANCES MFG. CO., LTD., Wuhu (CN)

(21) Appl. No.: 19/345,075

(22) Filed: Sep. 30, 2025

(30) Foreign Application Priority Data
Sep. 30, 2024 (CN) 202411389045.2

(51) Int. Cl. F16K 11/076; F16K 11/074; F24H 1/14; F24H 9/13

(52) U.S. Cl. CPC F16K 11/076; F16K 11/074; F24H 1/145; F24H 9/139

(57) ABSTRACT

A valve device includes a valve body; a first shield member; and a valve core assembly rotatably provided in the valve cavity. The valve body is provided with a valve cavity, a water inlet passage, a first water outlet passage, and a second water outlet passage communicating with the valve cavity. The first water outlet passage has a first water port communicating with the valve cavity, and the second water outlet passage has a second water port communicating with the valve cavity. The first shield member is provided with a water passing port, and the first water port communicates with the valve cavity via the water passing port.

### CROSS-REFERENCE TO RELATED APPLICATION

This application claims priority to Chinese Patent Application No. 202411389045.2, filed on Sep. 30, 2024, the entire contents of which are incorporated herein by reference.

### TECHNICAL FIELD

The present application relates to the technical field of water heaters, and in particular to a valve device and a gas water heater.

### BACKGROUND

With the continuous improvement of people's living standards, the pursuit of comfortable bathing experiences has grown increasingly. Gas water heaters, relying by their fast heating speed and large water flow, have become the preferred type for many users.

However, gas water heaters in in the related art have significant fluctuations in outlet water temperature. For instance, when water flow varies, the water temperature may alternate between cold and hot; additionally, if the water is turned off and then on again during use, it may first become hot and then cold.

### BRIEF DESCRIPTION OF THE DRAWINGS

In order to more clearly illustrate the technical solutions in the embodiments of the present application or in the related art, drawings used in the embodiments or in the related art will be briefly described below. Obviously, the drawings in the following description are only some embodiments of the present application. It will be apparent to those skilled in the art that other figures can be obtained according to the structures shown in the drawings without creative work.

FIG. 1 is a schematic structural diagram of a valve device according to an embodiment of the present application.

FIG. 2 is an exploded schematic diagram of the valve device according to an embodiment of the present application.

FIG. 3 is a cross-sectional view of the valve device according to an embodiment of the present application.

FIG. 4 is a schematic diagram of a matching structure of a valve core assembly, a first shield member, and a fix sleeve in a valve device according to an embodiment of the present application.

FIG. 5 is a schematic structural diagram of the valve core assembly according to an embodiment of the present application.

FIG. 6 is another perspective view of the embodiment shown in FIG. 5.

FIG. 7 is a schematic structural diagram of a first shield member and a fix sleeve according to an embodiment of the present application.

FIG. 8 is a schematic diagram of an assembly of a valve body, a valve core assembly, and a fix sleeve according to an embodiment of the present application.

FIG. 9 is a schematic diagram of a valve body from another perspective according to an embodiment of the present application.

FIG. 10 is a schematic diagram of a gas water heater according to an embodiment of the present application.

### DESCRIPTION OF REFERENCE SIGNS

| Reference | | Reference | |
|---|---|---|---|
| Signs | Name | Signs | Name |
| 100 | valve device | 211 | stopper |
| 1 | valve body | 22 | second valve core |
| 101 | valve cavity | 22a | flow passing port |
| 101a | peripheral wall surface | 221 | protruding shaft |
| 11 | water inlet passage | 23 | rotation shaft |
| 111 | water inlet port | 231 | second limiter |
| 12 | first water outlet passage | 3 | drive assembly |
| 121 | first water port | 4 | fix sleeve |
| 13 | second water | 41 | assembly hole |
| | outlet passage | | |
| 131 | second water port | 411 | first limiter |
| 14 | second shield member | 5 | first shield member |
| 141 | assembly hole | 501 | water passing port |
| 15 | installation port | 200 | water inlet pipe |
| 2 | valve core assembly | 300 | water outlet pipe |
| 21 | first valve core | 400 | heat exchanger |

The realization of the purposes, functional features and advantages of the present application will be further explained with reference to the accompanying drawings in combination with the embodiments.

### DETAILED DESCRIPTION OF EMBODIMENTS

In order to better understand the technical solution of the present application, the technical solutions in the embodiments of the present application will be clearly and completely described below with reference to the drawings in the embodiments of the present application. Obviously, the described embodiments are only a part of the embodiments of the present application and not all of them. Based on the embodiments in the present application, all other embodiments obtained by those skilled in the art without creative efforts fall within the protection scope of the present application.

Meanwhile, the meaning of “and/of” appearing in the present application includes three parallel solutions. For example, “A and/or B” includes only A, or only B, or both A and B.

Besides, the descriptions associated with, “first” and “second”, etc. in the present application are merely for descriptive purposes, and cannot be understood as indicating or suggesting relative importance or implicitly indicating the number of the indicated technical feature. Therefore, the feature associated with “first” or “second” can expressly or implicitly include at least one such feature. In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

The gas water heaters in the related art may have large fluctuations in the outlet water temperature during use, mainly in the following situations: 1. Temperature rise when the water is turned off. After the water is turned off, the heat stored in the heat exchanger will heat the water in the heat exchanger to a very high temperature. When the water is turned on again, the outlet water temperature will be too high; 2. Secondary startup fluctuation. When the water is turned off and then turned on again during water use, the above-mentioned temperature rise problem may occur, resulting in too high an outlet water temperature. At the same time, the device startup process takes a certain amount of time, and the cold water cannot be instantly heated to the required water temperature. Then the outlet water temperature will first rise, then fall, and then remain constant, that is, the water temperature will fluctuate between hot and cold; 3. When the water volume fluctuates, the outlet water temperature will fluctuate between hot and cold.

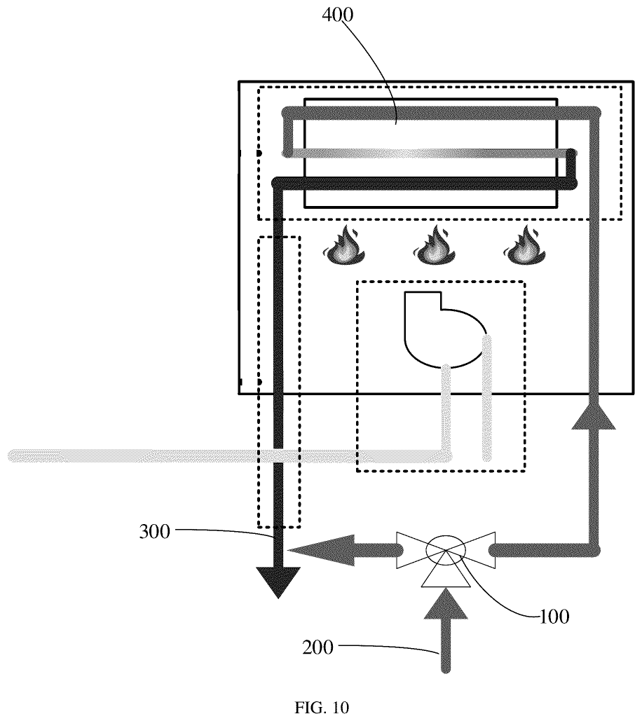

Based on this, the present application provides a valve device 100, which is applied to a gas water heater. As shown in FIG. 10, the gas water heater includes a water inlet pipe 200, a water outlet pipe 300, and a heat exchanger 400. The valve device 100 is connected between the water inlet pipe 200, the water inlet end of the heat exchanger 400, and the water outlet pipe 300. By adjusting the amount of water entering the water inlet end of the heat exchanger 400 and the water outlet pipe 300, the outlet water temperature fluctuation is improved and the constant temperature performance is improved. The structure of the valve device 100 will be described in the following by way of an embodiment.

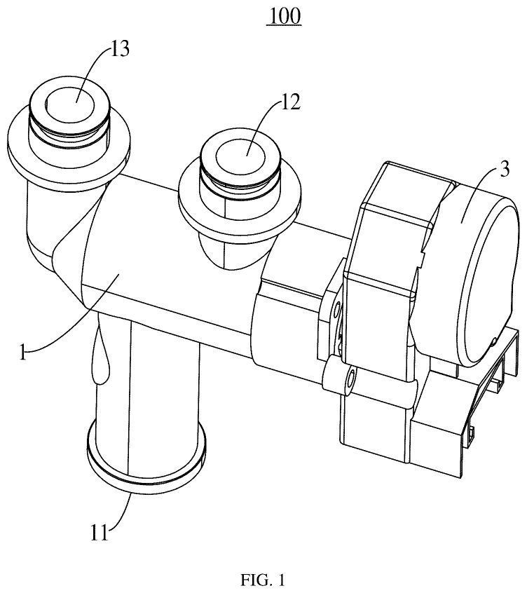

As shown in FIG. 1 to FIG. 3, the valve device 100 includes a valve body 1, a first shield member 5 and a valve core assembly 2. The valve body 1 is provided with a valve cavity 101, a water inlet passage 11, a first water outlet passage 12 and a second water outlet passage 13 communicating with the valve cavity 101. The first water outlet passage 12 has a first water port 121 communicating with the valve cavity 101, and the second water outlet passage 13 has a second water port 131 communicating with the valve cavity 101. The first shield member 5 is fixedly installed in the valve cavity 101. The first shield member 5 is provided with a water passing port 501. The first water port 121 communicates with the valve cavity 101 via the water passing port 501. The valve core assembly 2 is rotatably provided in the valve cavity 101. The valve core assembly 2 includes a first valve core 21 and a second valve core 22 which are axially spaced apart. The first valve core 21 and the first shield member 5 rotate to cooperatively block or unblock the water passing port 501, which is used to adjust the flow area between the valve cavity 101 and the first water outlet passage 12. The second valve core 22 rotates in the valve cavity 101 to block or unblock the second water port 131, which is used to adjust the flow area between the valve cavity 101 and the second water outlet passage 13.

In this embodiment, the valve body 1 serves as the outer housing of the valve device 100. The valve body 1 is provided with a valve cavity 101, a water inlet passage 11, a first water outlet passage 12 and a second water outlet passage 13. It can be understood that the water flowing into the valve cavity 101 from the water inlet passage 11 can flow out from the first water outlet passage 12 and/or the second water outlet passage 13. Specifically, a first shield member 5 is fixedly provided in the valve cavity 101, and the first shield member 5 is provided with a water passing port 501. The first water outlet passage 12 has a first water port 121, and the first water port 121 communicates with the valve cavity 101 via the water passing port 501. The second water outlet passage 13 communicates with the valve cavity 101 via the second water port 131. Then, the water flow rate of the water passing port 501 and the second water outlet passage 131 can be adjusted by the valve core assembly 2 provided in the valve cavity 101 to achieve the adjustment of the water output of the first water outlet passage 12 and the second water outlet passage 13. In practical applications, the water inlet passage 11 may be a water inlet pipe, and the first water outlet passage 12 and the second water outlet passage 13 may be a water outlet pipe, so as to facilitate pipe installation.

It should be noted that the valve cavity 101, the water inlet passage 11, the first water outlet passage 12 and the second water outlet passage 13 in this embodiment are all formed on the valve body 1, and the water inlet passage 11, the first water outlet passage 12 and the second water outlet passage 13 are respectively independent of the valve cavity 101, and are respectively communicated with the valve cavity 101 through corresponding water ports. Specifically, the first water port 121 is provided at the connection between the first water outlet passage 121 and the valve cavity 101, the second water port 131 is provided at the connection between the second water outlet passage 131 and the valve cavity 101, and the water inlet port 111 is provided at the connection between the water inlet passage 11 and the valve cavity 101. That is, the valve cavity 101 and the first water outlet passage 121 are respectively provided at both sides of the first water port 121, the valve cavity 101 and the second water outlet passage 131 are respectively provided at both sides of the second water port 131, and the valve cavity 101 and the water inlet passage 11 are respectively provided at both sides of the water inlet port 111.

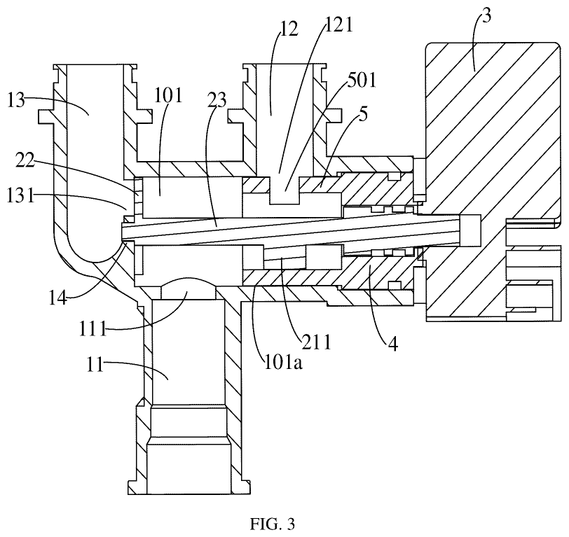

It can be understood that the relative positions of the water inlet passage 11, the first water outlet passage 12 and the second water outlet passage 13 and the valve cavity 101 can be determined according to actual conditions. For example, one or two of the water inlet passage 11, the first water outlet passage 12 and the second water outlet passage 13 can be located in the axial direction of the valve cavity 101, and the rest can be located in a direction forming an angle with the axial direction of the valve cavity 101; or, the water inlet passage 11, the first water outlet passage 12 and the second water outlet passage 13 can all be located in the axial direction of the valve cavity 101 or can all be located in a direction forming an angle with the axial direction of the valve cavity 101. As an example, as shown in FIG. 3, the valve cavity 101 is a cavity whose axial direction is parallel to the paper surface and extends laterally, the water inlet passage 11 is a passage extending approximately along the radial direction of the valve cavity 101 (that is, the water inlet passage 11 extends radially or slightly inclined along the valve cavity 101), and communicates with the valve cavity 101 through a water inlet port 111. In some embodiments, the water inlet port 111 is provided at the peripheral wall surface of the valve cavity 101; the first water outlet passage 12 is a passage extending approximately along the radial direction of the valve cavity 101 (that is, the first water outlet passage 12 extends radially or slightly inclined along the valve cavity 101), and communicates with the valve cavity 101 through a first water port 121. In some embodiment, the first water port 121 is provided at the peripheral wall surface of the valve cavity 101; the second water outlet passage 13 is a passage extending approximately along the radial direction of the valve cavity 101 (that is, the second water outlet passage 13 extends or is slightly inclined along the radial direction of the valve cavity 101), and communicates with the valve cavity 101 via the second water port 131. In some embodiments, the second water port 131 may be provided at the peripheral wall surface or one axial end of the valve cavity 101. It should be noted that when the second water port 131 is provided at one axial end of the valve cavity 101, the second water outlet passage 13 is provided at one axial side of the valve cavity 101, and the second water port 131 is provided at the side wall of the second water outlet passage 13.

The valve core assembly 2 is rotatably provided in the valve cavity 101, and the valve core assembly 2 includes a first valve core 21 and a second valve core 22 spaced apart in the axial direction. Both the first valve core 21 and the second valve core 22 can rotate in the valve cavity 101, where the first valve core 21 can rotate relative to the first shield member 5 to adjust the opening of the water passing port 501 to adjust the flow rate of the first water outlet passage 12, and the second valve core 22 is used to adjust the opening of the second water port 131 to adjust the flow rate of the second water outlet passage 13. It can be understood that the valve device 100 realizes the distribution function of the water flow rate through the rotation of the valve core assembly 2. In order to facilitate the rotation of the valve core assembly 2, the valve cavity 101 can be set as a cylindrical cavity, the valve core assembly 2 rotates around the central axis of the valve cavity 101, the first valve core 21 and the second valve core 22 are spaced apart in the axial direction of the valve cavity 101, and both the first valve core 21 and the second valve core 22 can rotate around the central axis of the valve cavity 101. In an embodiment, the first valve core 21 and the second valve core 22 may rotate synchronously or asynchronously.

It should be noted that, in this embodiment, a first shield member 5 having a water passing port 501 is provided in the valve cavity 101, and the water flow rate is adjusted by the rotational cooperation between the first valve core 21 and the first shield member 5. That is, in this embodiment, only the first valve core 21 needs to rotate to cover or unblock the water passing port 501 to adjust the opening of the water passing port 501. Compared with the method of setting a recess on the first valve core 21 in the related art, and rotating the first valve core 21 to drive the recess to rotate to adjust the opening of the recess, this embodiment does not need to specifically limit the structure of the first valve core 21 itself. Compared with the method of using the first valve core 21 to directly cooperate with the valve body 1 to adjust the opening of the first water port 121 in the related art, this embodiment does not need to limit the shape structure of the first water port 121 at the junction of the first water outlet passage 12 and the valve cavity 101, and by setting a water passing port 501 on the first shield member 5 independent of the valve body 1, on the one hand, the manufacturing difficulty of the valve body 1 structure can be reduced, and on the other hand, the structural design of the first valve core 21 can be simplified, thereby improving the overall production efficiency of the valve device 100.

It should be noted that, in actual application, the first shield member 5 may be set only at the position corresponding to the first water port 121, or shield members may be set at the positions corresponding to the second water port 131 and the first water port 121 respectively. When shield members are set at the positions corresponding to the two water ports, the first valve core 21 and the second valve core 22 respectively cooperate with the corresponding shield members.

It is understandable that the specific structure of the first shield member 5 can be determined according to actual conditions, for example, it can be a plate structure, a block structure, a cylindrical structure or some other structure, etc. It is understandable that the first shield member 5 can be an integral structure or a separate structure with the valve body 1.

In practical applications, the shape and structure of the first water port 121 can be determined according to actual conditions, such as circular, sector-shaped, square, strip-shaped or other shapes, etc. The shape and structure of the water passing port 501 can also be determined according to actual conditions, such as circular, sector-shaped, square, strip-shaped or other shapes, etc. The shape and structure of the second water port 131 can also be determined according to actual conditions, such as circular, sector-shaped, square, strip-shaped or other shapes, etc.

In practical application, the valve device 100 further includes a flow sensor, which is provided in the water inlet passage 11.

When the valve device 100 is applied to a gas water heater, the water inlet passage 11 communicates with the water inlet pipe 200, one of the first water outlet passage 12 and the second water outlet passage 13 is connected to the water inlet end of the heat exchanger 400, and the other is connected to the water outlet pipe 300. The following is an example in which the first water outlet passage 12 is connected to the water inlet end of the heat exchanger 400 and the second water outlet passage 13 is connected to the water outlet pipe 300.

Regarding the temperature rise when the water supply is turned off, when the water heater is turned on again after the water supply is turned off, the valve core assembly 2 rotates when the water is turned on, the first valve core 21 rotates to reduce or close the opening of the water passing port 501, and the second valve core 22 rotates to increase the opening of the second water outlet 131, so that more cold water flows out from the second water outlet and merges into the water outlet pipe 300, so as to reduce the water outlet temperature of the whole machine, solve the problem of temperature rise when the water supply is turned off, and prevent high temperature water from scalding users.

Regarding the secondary startup fluctuation, when the water heater is turned on again after the water is turned off, the valve core assembly 2 rotates when the water is turned on, so that the opening of the water passing port 501 decreases, and the opening of the second water port 131 increases, so that the outlet water temperature is reduced to the required temperature, improving the problem of water outage temperature rise. Then, after the equipment is started, the valve core assembly 2 continues to rotate, increasing the opening of the water passing port 501 and reducing the opening of the second water port 131, reducing the amount of cold water mixed into the water outlet pipe 300, and preventing the outlet water temperature of the whole machine from dropping too much. In this way, it is possible to ensure that the user's water temperature is stable when the water heater is started for the second time, thereby preventing fluctuations between hot and cold water.

Regarding water flow fluctuation, when the water flow suddenly increases, the water temperature will decrease. At this time, the valve core assembly 2 rotates to reduce the opening of the second water port 131, reduce the amount of cold water mixed into the water outlet pipe 300, and prevent the outlet water temperature from decreasing too much. When the water flow suddenly decreases, the water temperature will increase. At this time, the valve core assembly 2 rotates to increase the opening of the second water port 131, increase the amount of cold water mixed into the water outlet pipe 300, and prevent the outlet water temperature from increasing too much. In this way, the user's water temperature can be kept stable when the water flow of the water heater fluctuates.

In summary, in the valve device 100 of the technical solution of the present application, the valve body 1 is provided with a valve cavity 101 and a water inlet passage 11, a first water outlet passage 12 and a second water outlet passage 13 communicated with the valve cavity 101, the first water outlet passage 12 has a first water port 121, the second water outlet passage 13 has a second water port 131, a first shield member 5 is fixedly provided in the valve cavity 101, the first shield member 5 is provided with a water passing port 501, the first water port 121 communicates with the valve cavity 101 via the water passing port 501, and the second water outlet passage 13 communicates with the valve cavity 101 via the second water port 131. A rotatable valve core assembly 2 is provided in the valve cavity 101, and the valve core assembly 2 has the first valve core 21 and the second valve core 22 spaced apart, the first valve core 21 and the first blocking member 5 rotate to cooperate to block or unblock the water passing port 501, and adjust the flow area between the valve cavity 101 and the first water outlet passage 12, the second valve core 22 rotates to block or unblock the second water port 131, and adjust the flow area between the valve cavity 101 and the second water outlet passage 13, thereby realizing the water distribution function of the first water outlet passage 12 and the second water outlet passage 13. When the valve device 100 of this embodiment is applied to a gas water heater, the water output of the first water outlet passage 12 and the second water outlet passage 13 can be adjusted according to different working conditions of the gas water heater, which can improve the fluctuation of the water outlet temperature and enhance the constant temperature performance.

In addition, this embodiment sets an independent first shield member 5, and sets a water passing port 501 on the first shield member 5 independent of the valve body 1 to cooperate with the first valve core 21 to discharge water. On the one hand, it can reduce the manufacturing difficulty of the valve body 1 structure, and on the other hand, it can simplify the structural design of the first valve core 21, thereby improving the overall production efficiency of the valve device 100.

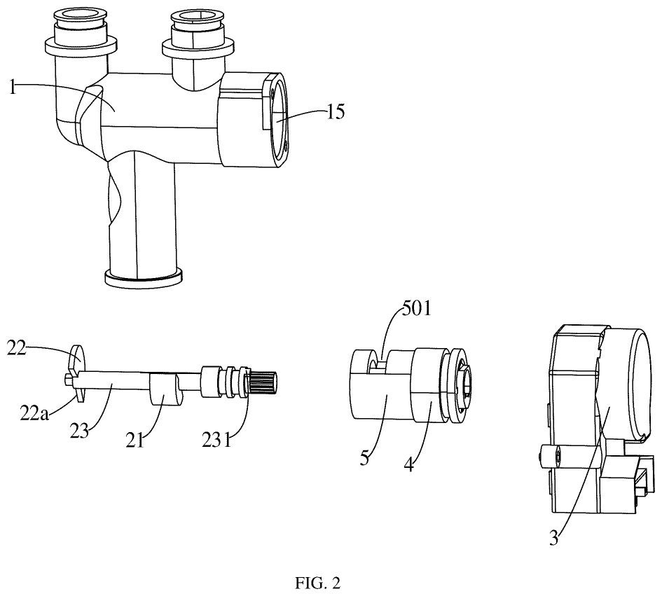

In an embodiment of the present application, as shown in FIG. 2 and FIG. 3, when the flow area between the valve cavity 101 and the first water outlet passage 12 increases, the flow area between the valve cavity 101 and the second water outlet passage 13 decreases; when the flow area between the valve cavity 101 and the first water outlet passage 12 decreases, the flow area between the valve cavity 101 and the second water outlet passage 13 increases.

In this embodiment, the relationship between the flow area between the valve cavity 101 and the first water outlet passage 12 and the flow area between the valve cavity 101 and the second water outlet passage 13 can be linearly anti-correlated or nonlinearly anti-correlated. When the water passing port 501 is blocked, the second water port 131 is fully opened; when the second water port 131 is blocked, the water passing port 501 is fully opened.

With such a configuration, the total flow rate entering the valve cavity 101 from the water inlet passage 11 can be equal to the sum of the water flow rates flowing out from the two water outlet passages.

In practical applications, the anti-correlation characteristic of the two flow areas can be achieved by setting the positions of the water passage 501 and the second water passage 131 and the first valve core 21 and the second valve core 22. For example, when the water passage 501 and the second water passage 131 are both opened along the radial direction of the valve cavity 101: the water passage 501 and the second water passage 131 are provided at the same side of the central axis of the valve cavity 101. At this time, the first valve core 21 and the second valve core 22 can be respectively provided at both sides of the central axis of the valve cavity 101, so that when the valve core assembly 2 rotates, the first valve core 21 and the second valve core 22 have an anti-correlated blocking area on the water passage 501 and the second water passage 131; or, the water passage 501 and the second water passage 131 are provided at opposite sides of the central axis of the valve cavity 101. At this time, the first valve core 21 and the second valve core 22 can be respectively provided at the same side of the central axis of the valve cavity 101, so that when the valve core assembly 2 rotates, the first valve core 21 and the second valve core 22 have an anti-correlated blocking area on the water passage 501 and the second water passage 131. For example, when the water passage 501 is opened along the radial direction of the valve cavity 101 and the second water passage 131 is provided along the axial direction of the valve cavity 101: the water passage 501 and the second water passage 131 are provided at the same side of the central axis of the valve cavity 101. At this time, the first valve core 21 and the second valve core 22 can be provided at both sides of the central axis of the valve cavity 101, so that when the valve core assembly 2 rotates, the first valve core 21 and the second valve core 22 have an anti-correlated blocking area on the water passage 501 and the second water passage 131; or, the water passage 501 and the second water passage 131 are provided at both sides of the central axis of the valve cavity 101. At this time, the first valve core 21 and the second valve core 22 can be respectively provided at the same side of the central axis of the valve cavity 101, so that when the valve core assembly 2 rotates, the first valve core 21 and the second valve core 22 have an anti-correlated blocking area on the water passage 501 and the second water passage 131.

In an embodiment of the present application, as shown in FIG. 2 and FIG. 3, the first water port 121 is provided at the peripheral wall surface 101a of the valve cavity 101; the first shield member 5 cooperates with the peripheral wall surface 101a of the valve cavity 101, and the water passing port 501 is radially aligned with the first water port 121 to establish fluid communication.

In this embodiment, the first water passage 121 is provided at the peripheral wall surface 101a of the valve cavity 101, and the first shield member 5 is cooperated with the peripheral wall surface 101a of the valve cavity 101, so that the water passage 501 is radially aligned with the first water passage 121 to establish fluid communication, and when the first valve core 21 rotates relative to the first shield member 5, the outer periphery of the first valve core 21 can block or unblock the water passage 501, so as to adjust the opening of the water passage 501. It can be understood that the water passage 501 is a radial water passage, which can reduce the generation of vortex in the valve cavity 101 and reduce resistance.

In practical applications, the first shield member 5 may be an arc structure or a cylindrical structure that matches the peripheral wall surface 101a of the valve cavity 101.

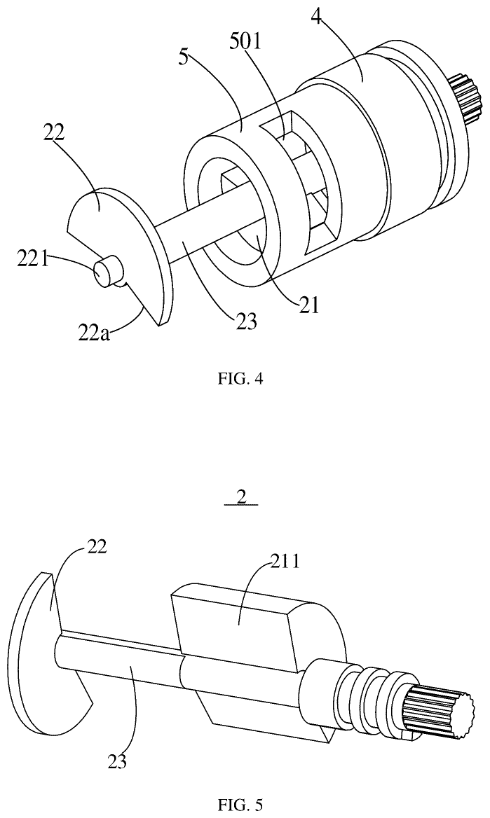

As an example, as shown in FIG. 2 to FIG. 4, the first shield member 5 is a cylinder; the outer periphery of the first shield member 5 is tightly cooperated with the peripheral wall surface 101a of the valve cavity 101, and the water passing port 501 passes through the inner and outer peripheries of the first shield member 5; the first valve core 21 is located inside the first shield member 5, and the outer periphery of the first valve core 21 is rotatably cooperated with the inner periphery of the first shield member 5 to block or unblock the water passing port 501.

By setting the first shield member 5 as a cylindrical structure, the outer periphery of the first shield member 5 is tightly cooperated with the peripheral wall surface 101a of the valve cavity 101, which can prevent water from leaking between the first shield member 5 and the peripheral wall surface 101a of the valve cavity 101, thereby ensuring the accuracy of flow control. The water passing port 501 runs through the inner and outer circumferences of the first shield member 5. At this time, the inner cavity of the first shield member 5 communicates with the valve cavity 101, and the water passing port 501 is radially water-passing. By locating the first valve core 21 inside the first shield member 5, the first valve core 21 is provided at the upstream side of the water passing port 501, so that when the first valve core 21 rotates to block the water passing port 501, the water pressure can be used to increase the blocking force of the first valve core 21 on the water passing port 501.

In an embodiment, as shown in FIG. 2 to FIG. 4, the water passing port 501 is extended along the peripheral direction of the first shield member 5.

It can be understood that the first valve core 21 rotates in the first shield member 5. In this embodiment, the water passing port 501 is extended along the peripheral direction of the first shield member 5, so that when the first valve core 21 rotates, the outer periphery of the first valve core 21 can move along the extension direction of the water passing port 501 to adjust the opening of the water passing port 501. Such a design is more conducive to the linear adjustment of the opening of the water passing port 501 by the first valve core 21, thereby facilitating the control of the water flow rate.

In an embodiment, the water passing port 501 may extend along the same opening width. In this embodiment, when the first valve core 21 rotates by a unit angle, the water flow area of the water passing port 501 increases or decreases in a consistent manner, thereby linearly adjusting the flow rate.

In an embodiment, the opening width of the water passing port 501 may change gradually. Such a design can improve the accuracy of the opening adjustment process of the water passing port 501 and achieve a wider adjustment range.

In an embodiment, as shown in FIG. 2 to FIG. 6, the first valve core 21 is a stopper 211. The outer periphery of the stopper 211 is rotatably cooperated with the inner periphery of the first shield member 5 to block or unblock the water passing port 501; the outer periphery of the stopper 211 is of an arc shape or a spherical surface.

It is understandable that the first valve core 21 is an arc-shaped block, a spherical block, a butterfly-shaped block or some other shape structures.

In an embodiment, the outer periphery of the first valve core 21 is of an arc shape, so that the outer periphery of the first valve core 21 is cooperated with the inner periphery of the first shield member 5, ensuring better blocking force and reducing resistance. In an embodiment, the radial cross section of the first valve core 21 is a sector.

In an embodiment, the central angle A1 corresponding to the outer periphery of the first valve core 21 satisfies: 800≤A1≤180°. It is understandable that the central angle corresponding to the outer periphery of the first valve core 21 should not be too small or too large. If it is too small, the water passing port 501 may not be completely blocked, which will affect the regulation of the water flow rate of the first water outlet passage 12; if it is too large, the first valve core 21 may rotate a longer angle before opening the water passing port 501, affecting the adjustment efficiency of the water passing port 501. Based on this, the present embodiment sets the central angle A1 corresponding to the outer periphery of the first valve core 21 to 80°≤A1≤180°, which can ensure that the first valve core 21 can completely block the water passing port 501 on the one hand, and on the other hand, it can ensure the adjustment efficiency of the water passing port 501, and prevent the first valve core 21 from rotating for too long and still failing to unblock the water passing port 501. In practical applications, in order to ensure a better adjustment effect, the central angle A1 corresponding to the outer periphery of the first valve core 21 can be 120°≤A1≤165°. In an embodiment, the central angle A1 is 160°.

In addition, compared with the cylindrical structure, the first valve core 21 in this embodiment has a smaller matching area with the peripheral wall surface 101a of the valve cavity 101, which can reduce movement resistance.

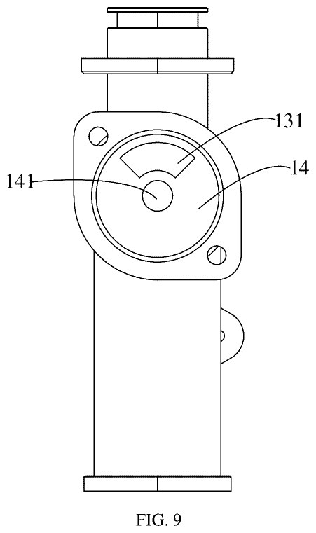

In an embodiment of the present application, as shown in FIG. 3 and FIG. 9, a second shield member 14 is provided in the valve body 1 to separate the second water outlet passage 13 from the valve cavity 101, and the second shield member 14 is provided with a second water port 131; the second valve core 22 is rotatably cooperated with the second shield member 14 to block or unblock the second water port 131.

In this embodiment, a second shield member 14 is provided in the valve body 1, and the second water port 131 is provided at the second shield member 14. The second valve core 22 adjusts the opening of the second water port 131 by rotating with the second shield member 14.

It can be understood that the specific structure of the second shield member 14 can be determined according to actual conditions, for example, it can be a plate-shaped structure, a block-shaped structure, a cylindrical structure or some other structures.

In actual application, the second shield member 14 can be an integral structure or a split structure with the valve body 1. In this embodiment, considering the assembly efficiency, it is preferred that the second shield member 14 is integrally formed with the valve body 1 to facilitate production and manufacturing. It can be understood that the manner in which the second shield member 14 and the valve body 1 are integrally formed can also be determined according to actual conditions. For example, when the valve body 1 is a metal part, the second shield member 14 and the valve body 1 can be integrally formed by a casting process. When the valve body 1 is a plastic part, the second shield member 14 and the valve body 1 can be integrally formed by a mold or 3D printing.

In an embodiment, as shown in FIG. 3 and FIG. 9, the second shield member 14 is a shielding plate; the second shield member 14 is provided at one axial end of the valve cavity 101, the second water passage 131 extends along the axial direction of the valve cavity 101, and the axial end face of the second valve core 22 is rotatably cooperated with the second shield member 14. It can be understood that the axial end face of the second valve core 22 is basically fitted with the axial end face of the second shield member 14, so that there is no flow gap or a very small amount of flow gap between the axial end face of the second valve core 22 and the axial end face of the second shield member 14, so as to ensure the blocking effect of the second valve core 22 on the second water passage 131.

In this embodiment, the second shield member 14 is set as a shielding plate. Compared with other structures such as a cylindrical structure or a block structure, the shielding plate has a simpler structure and shape, and is easier to be integrally formed inside the valve body 1, and the molding process is less difficult. The second water outlet passage 13 is separated from the valve cavity 101 by the shielding plate, and the second water port 131 is formed between the shielding plate and the inner wall of the valve body 1, so that when the second valve core 22 rotates in the valve cavity 101, it can rotate relative to the shielding plate to cover or unblock the second water port 131, thereby adjusting the flow at the second water port 131.

The shielding plate is provided at one axial end of the valve cavity 101, and the second water port 131 axially penetrates the shielding plate. The second water port 131 is provided at the shielding plate or between the shielding plate and the peripheral wall surface 101a of the valve cavity 101.

In an embodiment, when the periphery of the shielding plate is connected to the peripheral wall surface 101a of the valve cavity 101, the second water port 131 is directly formed by the opening of the shielding plate. In this way, when the second valve core 22 shields the second water port 131, the second valve core 22 can cooperate with the plate surface of the periphery of the second water port 131 to achieve a better water-isolating effect.

In an embodiment, a notch is provided at the side of the shielding plate, and the second water port 131 is formed by enclosing the notch and the peripheral wall surface 101a of the valve cavity 101. Such a design is more convenient for molding and manufacturing.

It is understandable that the shape and structure of the second water port 131 can be, for example, circular, fan-shaped, square, strip-shaped or other shapes. The radial cross-sectional shape of the second valve core 22 can also be determined according to actual conditions, for example, it can be fan-shaped, square, circular or other shapes. Considering that the second valve core 22 rotates in the valve cavity 101, in order to better block water flow, in this embodiment, the second water port 131 is set as a fan-shaped hole with the central axis of the valve cavity 101 as the center. Correspondingly, the radial cross section of the second valve core 22 is fan-shaped, so that the outer periphery of the second valve core 22 is of an arc shape adapted to the peripheral wall surface 101a of the valve cavity 101. Specifically, the outer periphery of the second valve core 22 is substantially tangent to the peripheral wall surface 101a of the valve cavity 101. Substantially tangent here means that the outer periphery of the second valve core 22 is in contact or substantially in contact with the peripheral wall surface 101a of the valve cavity 101, so that there is no flow gap or a very small amount of flow gap between the outer periphery of the second valve core 22 and the peripheral wall surface 101a of the valve cavity 101, so as to further enhance the blocking effect of the second valve core 22 on the second water port 131. The center angle of the second valve core 22 is greater than the center angle of the second water port 131. In this way, the second valve core 22 can completely block the second water port 131 during the rotation process, and the second valve core 22 can adjust the opening size of the second water port 131.

It can be understood that, as shown in FIG. 6, the center angle of the second valve core 22 should not be too small or too large. If it is too small, it may not be able to completely block the second water port 131; if it is too large, it may cause the second valve core 22 to rotate a larger angle before it can open the second water port 131, affecting the adjustment efficiency of the second water port 131, and it may also happen that both the first water port 121 and the second water port 131 are blocked. Based on this, in this embodiment, the center angle A2 of the second valve core 22 is set to meet 180°≤A2≤280°, which can ensure that the second valve core 22 can completely block the second water port 131 on the one hand, and on the other hand, it can ensure the adjustment efficiency of the second water port 131, and prevent the first water port 121 and the second water port 131 from being blocked. In actual application, in order to ensure a better adjustment effect, the center angle A2 of the second valve core 22 can be 180°≤A2≤240°.

Further, the second valve core 22 is a baffle, and the axial end face of the baffle rotates with the axial end face of the baffle plate. The second valve core 22 is provided with a flow passing port 22a. In an embodiment, the flow passing port 22a can be a through hole or a notch on the second valve core 22. When the second valve core 22 rotates, it can drive the flow passing port 22a to move with respect to the second water port 131 to adjust the overlapping area between the flow passing port 22a and the second water port 131. It can be understood that when the second valve core 22 rotates to drive the flow passing port 22a to overlap with the second water port 131, the valve cavity 101 and the second water outlet passage 13 are in a conducting state, and the conducting area between the valve cavity 101 and the second water outlet passage 13 is adjusted by adjusting the overlapping area. When the disk of the second valve core 22 completely blocks the second water port 131, the second water outlet passage 13 and the valve cavity 101 are in a cut-off state.

Specifically, the shielding plate is provided with an assembly hole 141, and the axial end surface of the second valve core 22 is provided with a protruding shaft 221, which is rotatably installed in the assembly hole 141. It can be understood that the central axis of the protruding shaft 221 is consistent with the central axis of the valve cavity 101. During assembly, the assembly hole 141 and the protruding shaft 221 can play a role in mounting and positioning the valve core assembly 2.

In an embodiment of the present application, as shown in FIG. 2 to FIG. 6, the valve core assembly 2 further includes a rotation shaft 23 connecting the first valve core 21 and the second valve core 22, and the first valve core 21 and the second valve core 22 are respectively provided at two radial sides of the rotation shaft 23.

In this embodiment, by connecting both the first valve core 21 and the second valve core 22 to the rotation shaft 23, the rotation shaft 23 can drive the first valve core 21 and the second valve core 22 to rotate simultaneously, thereby, the flow rate of the first water outlet passage 12 and the second water outlet passage 13 can be adjusted only by driving the rotation shaft 23 to rotate. In an embodiment, the rotation axis of the rotation shaft 23 is consistent with the central axis of the valve cavity 101, and the first valve core 21 and the second valve core 22 rotate around the central axis of the valve cavity 101. Connecting the first valve core 21 and the second valve core 22 through the rotation shaft 23 can further improve the structural reliability of the valve core assembly 2 when rotating, and ensure the rotation synchronization of the first valve core 21 and the second valve core 22.

Furthermore, the first valve core 21 and the second valve core 22 are respectively provided at both radial sides of the rotation shaft 23. Such a configuration, on the one hand, makes the rotational movement of the entire valve core assembly 2 more stable, preventing the two valve cores from being prone to tilting when they are provided at the same side of the rotation shaft 23; on the other hand, it can smoothly achieve the anti-correlation characteristic between the opening of the water passing port 501 and the opening of the second water outlet 131.

In an embodiment of the present application, as shown in FIG. 2 to FIG. 4 and FIG. 8, the valve body 1 is further provided with an installation port 15 communicating with the valve cavity 101; the valve device 100 further includes a fix sleeve 4 and a drive assembly 3 installed on the fix sleeve 4, the fix sleeve 4 is sealingly installed in the installation port 15, and the fix sleeve 4 is provided with an assembly hole 41. One end of the rotation shaft 23 distant from the second valve core 22 is sealed and cooperated with the assembly hole 41, and extends out of the assembly hole 41 to be driven and connected with the drive assembly 3.

Specifically, the fix sleeve 4 and the installation port 15 can be sealed and installed by a sealing ring, and the rotation shaft 23 of the valve core assembly 2 extends from the valve cavity 101 through the assembly hole 41 to the outside of the fix sleeve 4, and the rotation shaft 23 and the assembly hole 41 can be sealed by a sealing ring. In an embodiment, the drive assembly 3 is a stepping motor, and the part of the rotation shaft 23 extending outside the fix sleeve 4 can be a gear shaft to be connected to the stepping motor drive. In an embodiment, the drive assembly 3 and the fix sleeve 4 can be fixed by screws.

In an embodiment, the installation port 15 and the second blocking member 14 can be respectively provided at the axial ends of the valve cavity 101, and the installation port 15 and the valve cavity 101 are coaxially provided, and the assembly hole 141 on the second blocking member 14 and the valve cavity 101 are coaxially provided. Therefore, during assembly, it is only necessary to insert the valve core assembly 2 from the installation port 15 along the axial direction of the valve cavity 101, so that the protruding shaft 221 of the second valve core 22 can be assembled in the assembly hole 141 of the second blocking member 14. With this design, there is no need to perform installation operations on the valve core assembly 2 in multiple directions, which further simplifies the installation operation and improves the installation convenience.

Further, as shown in FIG. 2 to FIG. 4 and FIG. 7, the first shield member 5 is fixedly connected to the fix sleeve 4. With such a configuration, during assembly, the first shield member 5 can be first installed with the fix sleeve 4 outside the valve body 1, and then the fix sleeve 4 can be installed to the installation opening 15 of the valve body 1, and the first shield member 5 can be installed into the valve cavity 101 at the same time, that is, during the installation process to the valve body 1, the staff only needs to take the fix sleeve 4 for assembly operation, and there is no need to specifically limit the first shield member 5 by hand, thereby reducing the difficulty of installation and improving the assembly efficiency.

In order to further improve the convenience of assembly, in an embodiment, the first shield member 5 and the fix sleeve 4 are integrally formed. Such configuration allows the first shield member 5 and the fix sleeve 4 to be formed and manufactured at the same time, eliminating the assembly steps of the first shield member 5 and the fix sleeve 4, further improving the assembly efficiency.

As an example, during assembly, the rotation shaft 23 of the valve core assembly 2 can be first installed in the assembly hole 41 of the fixed sleeve 4, so that the first valve core 21 is aligned with the water passing port 501 on the first shield member 5. At this time, the valve core assembly 2, the first shield member 5 and the fixed sleeve 4 are assembled into an integral component, and then the integral component is inserted into the valve cavity 101 from the installation port 15, so that the protruding shaft 221 of the second valve core 22 is installed in the assembly hole 141 on the baffle plate. At the same time, the first shield member 5 is assembled with the inner wall of the valve cavity 101, and the fixed sleeve 4 is sealed with the installation port 15; then the drive assembly 3 is installed on the fixed sleeve 4, so that the drive assembly 3 is driven and connected to the rotation shaft 23, thereby realizing the assembly of the valve body 1, the valve core assembly 2, the first shield member 5, the fixed sleeve 4 and the drive assembly 3.

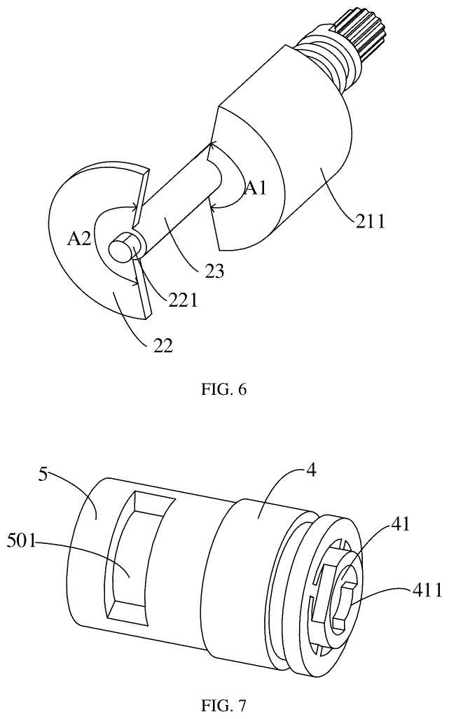

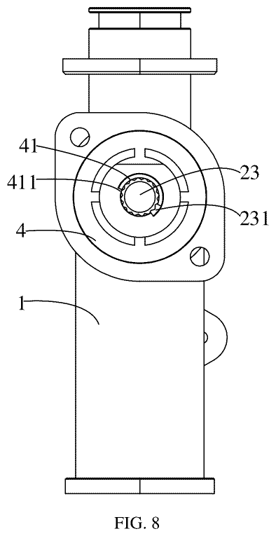

In an embodiment, as shown in FIG. 7 and FIG. 8, the assembly hole 41 is provided with a first limiter 411, and the rotation shaft 23 is provided with a second limiter 231; the second limiter 231 is used to cooperate with the first limiter 411 to limit the rotation angle of the rotation shaft 23. Such a configuration can prevent the rotation shaft 23 from excessive rotation and affecting the distribution of the water flow rate.

In an embodiment, the first limiter 411 can be an arc-shaped rib provided at the hole wall of the assembly hole 41, so that the first limiter 411 has two limiting surfaces along the peripheral direction. When the rotation shaft 23 rotates in the assembly hole 41, the two limiting surfaces can respectively abut against the second limiter 231 on the rotation shaft 23 to limit the rotation angle of the rotation shaft 23.

The present application further provides a gas water heater, as shown in FIG. 10, which includes a water inlet pipe 200, a water outlet pipe 300, a heat exchanger 400 and a valve device 100. The specific structure of the valve device 100 refers to the above embodiment. Since the present gas water heater adopts all the technical solutions of all the above embodiments, it at least has all the effects brought by the technical solutions of the above embodiments, which will not be described one by one here. The water inlet passage 11 communicates with the water inlet pipe 200, one of the first water outlet passage 12 and the second water outlet passage 13 communicates with the water inlet end of the heat exchanger 400, and the other communicates with the water outlet pipe 300.

Take the example that the first water outlet passage 12 is connected to the water inlet end of the heat exchanger 400, and the second water outlet passage 13 is connected to the water outlet pipe 300 for explanation.

Regarding the temperature rise when the water supply is turned off, when the water heater is turned on again after the water supply is turned off, the valve core assembly 2 rotates when the water is turned on, the first valve core 21 rotates to reduce or close the opening of the water passing port 501, and the second valve core 22 rotates to increase the opening of the second water outlet 131, so that more cold water flows out from the second water outlet and merges into the water outlet pipe 300, so as to reduce the water outlet temperature of the whole machine, solve the problem of temperature rise when the water supply is turned off, and prevent high temperature water from scalding users.

Regarding the secondary startup fluctuation, when the water heater is turned on again after the water is turned off, the valve core assembly 2 rotates when the water is turned on, so that the opening of the water passing port 501 decreases, and the opening of the second water port 131 increases, so that the outlet water temperature is reduced to the required temperature, improving the problem of water outage temperature rise; then after the equipment is started, the valve core assembly 2 continues to rotate, increasing the opening of the water passing port 501 and reducing the opening of the second water port 131, reducing the amount of cold water mixed into the water outlet pipe 300, and preventing the outlet water temperature of the whole machine from dropping too much. In this way, it is possible to ensure that the user's water temperature is stable when the water heater is started for the second time, avoiding hot and cold.

Regarding water flow fluctuation, when the water flow suddenly increases, the water temperature will decrease. At this time, the valve core assembly 2 rotates to reduce the opening of the second water port 131, reduce the amount of cold water mixed into the water outlet pipe 300, and prevent the outlet water temperature from decreasing too much. When the water flow suddenly decreases, the water temperature will increase. At this time, the valve core assembly 2 rotates to increase the opening of the second water port 131, increase the amount of cold water mixed into the water outlet pipe 300, and prevent the outlet water temperature from increasing too much. In this way, the user's water temperature can be kept stable when the water flow of the water heater fluctuates.

It can be seen from this that the gas water heater provided in the present application can improve the fluctuation of water outlet temperature and enhance the constant temperature performance.

The above descriptions are only some embodiments of the present application, and do not limit the scope of the present application. Under the inventive concept of the present application, equivalent structural transformations made using the contents of the description and drawings of the present application, or direct/indirect application in other related technical fields, are included in the scope of the present application.

What is claimed is:

1. A valve device, comprising:
a valve body provided with a valve cavity, a water inlet passage, a first water outlet passage, and a second water outlet passage communicating with the valve cavity;
a first shield member fixedly installed in the valve cavity; and
a valve core assembly rotatably provided in the valve cavity, wherein:
the first water outlet passage has a first water port communicating with the valve cavity, and the second water outlet passage has a second water port communicating with the valve cavity;
the first shield member is provided with a water passing port, the first water port communicating with the valve cavity via the water passing port;
the valve core assembly comprises a first valve core and a second valve core axially spaced apart;
the first valve core and the first shield member rotate to cooperatively block or unblock the water passing port for adjusting a flow area between the valve cavity and the first water outlet passage; and
the second valve core rotates in the valve cavity to block or unblock the second water port for adjusting a flow area between the valve cavity and the second water outlet passage.

2. The valve device according to claim 1, wherein:
when the flow area between the valve cavity and the first water outlet passage increases, the flow area between the valve cavity and the second water outlet passage decreases; or
when the flow area between the valve cavity and the first water outlet passage decreases, the flow area between the valve cavity and the second water outlet passage increases.

3. The valve device according to claim 1, wherein:
the first water outlet is provided at a peripheral wall surface of the valve cavity;
the first shield member cooperates with the peripheral wall surface of the valve cavity; and
the water outlet is radially aligned with the first water outlet to establish fluid communication with the first water outlet.

4. The valve device according to claim 3, wherein:
the first shield member is cylindrical;
an outer periphery of the first shield member is engaged with the peripheral wall surface of the valve cavity, the water passing port penetrating both the inner and outer peripheries of the first shield member; and
the first valve core is provided inside the first shield member and is rotatably cooperated with the inner periphery of the first shield member to block or unblock the water passing port.

5. The valve device according to claim 4, wherein the water passing port extends along a peripheral direction of the first shield member, and wherein the first valve core is a stopper.

6. The valve device according to claim 5, wherein an outer periphery of the stopper is of an arc shape, and wherein a central angle A1 corresponding to the outer periphery of the stopper is not less than 800 and not greater than 180°.

7. The valve device according to claim 1, wherein:
a second shield member is provided in the valve body to separate the second water outlet passage from the valve cavity, the second shield member being provided with the second water port; and
the second valve core is rotatably cooperated with the second shield member to block or unblock the second water port.

8. The valve device according to claim 7, wherein the second shield member is a shielding plate provided at one axial end of the valve cavity, the second water outlet extending along an axial direction of the valve cavity, and an axial end face of the second valve core being rotatably cooperated with the second shield member.

9. The valve device according to claim 8, wherein:
a periphery of the shielding plate is connected to the peripheral wall surface of the valve cavity, the second water port being formed by an opening in the shielding plate; or
the shielding plate is provided with a notch which encloses with the peripheral wall surface of the valve cavity to form the second water outlet.

10. The valve device according to claim 7, wherein:
the second valve core is a baffle;
the second valve core is provided with a flow passing port; and
when the second valve core rotates, the flow passing port is driven to move with respect to the second water port to adjust an overlapping area between the flow passing port and the second water port.

11. The valve device according to claim 1, wherein the valve core assembly further comprises a rotation shaft connecting the first valve core and the second valve core, the first valve core and the second valve core being respectively provided at two radial sides of the rotation shaft.

12. The valve device according to claim 11, wherein:
the valve body is further provided with an installation port communicating with the valve cavity;
the valve device further comprises a fix sleeve and a drive assembly installed on the fix sleeve, the fix sleeve being sealingly installed on the installation port, and the fix sleeve being provided with an assembly hole; and
one end of the rotation shaft distant from the second valve core is sealingly cooperated with the assembly hole and extends out of the assembly hole to be drivingly connected to the drive assembly.

13. The valve device according to claim 12, wherein the first shield member is fixedly connected to the fix sleeve.

14. The valve device according to claim 13, wherein the first shield member and the fix sleeve are integrally formed.

15. The valve device according to claim 12, wherein:
the assembly hole is provided with a first limiter, and the rotation shaft is provided with a second limiter; and
the second limiter cooperates with the first limiter to limit a rotation angle of the rotation shaft.

16. A gas water heater, comprising:
a water inlet pipe;
a water outlet pipe;
a heat exchanger; and
the valve device according to claim 1,
wherein the water inlet passage communicates with the water inlet pipe, one of the first water outlet passage and the second water outlet passage communicating with a water inlet end of the heat exchanger, and another one of the first water outlet passage and the second water outlet passage communicating with the water outlet pipe.
